(19) United States
(12) Patent Application Publication
(10) Pub. No.: US 2016/0288419 A1
(43) Pub. Date: Oct. 6, 2016

(54) MANUFACTURING METHOD OF THREE-DIMENSIONAL OBJECT

(71) Applicant: MIMAKI ENGINEERING CO., LTD., Nagano (JP)

(72) Inventor: MASARU OHNISHI, NAGANO (JP)

(73) Assignee: MIMAKI ENGINEERING CO., LTD., NAGANO (JP)

(21) Appl. No.: 15/076,619

(22) Filed: Mar. 21, 2016

(30) Foreign Application Priority Data
Apr. 1, 2015 (JP) 2015-074967

(51) Int. Cl. B29C 67/00

(52) U.S. Cl. CPC B29C 67/0081; B33Y 10/00

(57) ABSTRACT

Provided is a manufacturing method of a three-dimensional object that enables to manufacture the three-dimensional object accurately even in the case of manufacturing a relatively large three-dimensional object. The manufacturing method of a three-dimensional object includes a 3D object forming step of forming the three-dimensional object or a base model of the three-dimensional object by laminating cured ink layers, by repeating an uncured ink layer forming step of forming an uncured ink layer, which is an uncured photo-curing ink layer, by screen printing and a cured ink layer forming step of forming a cured ink layer by curing a predetermined portion of the uncured ink layer by irradiating light to the predetermined portion of the uncured ink layer; and an uncured ink removing step of removing uncured photo-curing ink, which did not cure in the cured ink layer forming step, after the 3D object forming step.

### CROSS REFERENCE TO RELATED APPLICATIONS

This application claims the priority benefit of Japanese Patent Application No. 2015-074967, filed on Apr. 1, 2015. The entirety of the above-mentioned patent application is hereby incorporated by reference herein and made a part of this specification.

### TECHNICAL FIELD

The present disclosure relates to a manufacturing method of a three-dimensional object.

### DESCRIPTION OF THE BACKGROUND ART

Conventionally, a manufacturing method of a photo-fabrication product is known (for example, see Patent Document 1). In the manufacturing method of the photo-fabrication product described in Patent Document 1, firstly, photo-curing resin liquid is supplied onto a forming table by a dispenser, and the supplied photo-curing resin liquid is swept by a recoater to form one layer of coat layer, and then light is irradiated to a predetermined portion of the coat layer to form a first layer of hardened resin layer. Thereafter, the photo-curing resin liquid is supplied, by the dispenser, to an outer side of the hardened resin layer formed as the first layer, the supplied photo-curing resin liquid is swept by the recoater to form the next layer of coat layer, and then light is irradiated to a predetermined portion of this coat layer to form a second layer of hardened resin layer above the first layer of hardened resin layer. In this manufacturing method, hereafter the third and subsequent layers of hardened resin layers are sequentially deposited in the same way to manufacture the photo-fabrication product.

[Patent Document 1] JP 2007-76090 A

In the manufacturing method of the photo-fabrication product described in Patent Document 1, the photo-curing resin liquid is supplied by the dispenser, and the supplied photo-curing resin liquid is swept by the recoater to form one layer of coat layer, so it becomes difficult to form the coat layer having a certain thickness when an area of the coat layer becomes larger. That is, in this manufacturing method, when the area of the coat layer is made larger for manufacturing larger photo-fabrication product, it becomes difficult to form the coat layer having a certain thickness, as a result of which it becomes difficult to form a hardened resin layer having a certain thickness. Thus, in this manufacturing method, it becomes difficult to accurately fond the photo-fabrication product in cases where a large photo-fabrication product is to be formed.

Thus, the present disclosure provides a manufacturing method of a three-dimensional object that enables to manufacture the three-dimensional object accurately even in the case of manufacturing a relatively large three-dimensional object.

### SUMMARY

Therefore, the manufacturing method of a three-dimensional object of the present disclosure includes: a 3D object forming step of forming the three-dimensional object or a base model of the three-dimensional object by laminating cured ink layers, by repeating an uncured ink layer forming step of forming an uncured ink layer, which is an uncured photo-curing ink layer, by screen printing and a cured ink layer forming step of forming a cured ink layer by curing a predetermined portion of the uncured ink layer by irradiating light to the predetermined portion of the uncured ink layer; and an uncured ink removing step of removing uncured photo-curing ink, which did not cure in the cured ink layer forming step, after the 3D object forming step.

In the manufacturing method of a three-dimensional object of the present disclosure, since the uncured ink layer, which is the uncured photo-curing ink layer, is formed by the screen printing, the uncured ink layer having a certain thickness in accordance with a thickness of a screen can be formed even if the area of the uncured ink layer becomes large. That is, in the present disclosure, even if the area of the uncured ink layer is made large in order to manufacture a large three-dimensional object, the uncured ink layer having a certain thickness can still be formed. Accordingly, in the present disclosure, even in the case of manufacturing a relatively large three-dimensional object, the predetermined portion of the uncured ink layer having a certain thickness can be cured to form the cured ink layer having a certain thickness. As a result, in the present disclosure, even in the case of manufacturing a relatively large three-dimensional object, the three-dimensional object can be manufactured accurately by the laminated cured ink layers.

Further, in the present disclosure, since the uncured photo-curing ink that did not cure in the cured ink layer forming step is removed in the uncured ink removing step, the removed uncured photo-curing ink can be reused in the screen printing of the uncured ink layer forming step. Accordingly, in the present disclosure, the amount of the photo-curing ink used to manufacture one piece of three-dimensional object can be reduced.

In the present disclosure, in the cured ink layer forming step, it is preferable that light is irradiated to surround the cured ink layer and onto an outer circumferential portion of the uncured ink layer to cure the outer circumferential portion of the uncured ink layer, so as to form an outflow preventing section for preventing an outflow of the uncured photo-curing ink to an outer circumferential side of the uncured ink layer. With this configuration, the outflow of the uncured photo-curing ink to the outer circumferential side of the uncured ink layer can be prevented by the outflow preventing section even if a frame member or the like for preventing the outflow of the uncured photo-curing ink to the outer circumferential side of the uncured ink layer is not provided. Thus, a configuration of a manufacturing device of the three-dimensional object can be simplified. Further, with this configuration, the screen to be used in the screen printing can be retained by the outflow preventing section.

In the present disclosure, the uncured photo-curing ink may for example be ultraviolet curing ink. In this case, the uncured photo-curing ink is preferably water-soluble ultraviolet curing ink. With this configuration, for example, in the case where a manufactured three-dimensional object or a base model of the three-dimensional object is defective, the cured photo-curing ink (that is, three-dimensional object or the base model of the three-dimensional object) can be dissolved in water to return to an uncured state. Further, the photo-curing ink returned to the uncured state can be reused in the screen printing in the uncured ink layer forming step.

In the present disclosure, for example, the uncured photo-curing ink may contain metal powder, ceramic powder, or thermo-curing resin powder, and the manufacturing method of the three-dimensional object further includes: a heating step of heating the base model of the three-dimensional object formed by the 3D object forming step to manufacture the three-dimensional object, and the heating step taking place after the uncured ink removing step.

In the present disclosure, a light source that irradiates the light to predetermined portions of the uncured ink layer in the cured ink layer forming step may be a UV-LED array in which a plurality of light emitting diodes that emit ultraviolet ray are arranged, or a laser device.

As above, according to the manufacturing method of the three-dimensional object of the present disclosure, the three-dimensional object can be manufactured highly accurately even in the case where a relatively large three-dimensional object is to be manufactured.

### BRIEF DESCRIPTION OF THE DRAWINGS

FIGS. 1A to 1C are diagrams for explaining a manufacturing method of a three-dimensional object according to an embodiment of the present disclosure, where FIG. 1A is a diagram for explaining an uncured ink layer forming step, and FIGS. 1B and 1C are diagrams for explaining a cured ink layer forming step.

FIGS. 2A and 2B are diagrams illustrating a state after a 3D object forming step of the embodiment of the present disclosure, where FIG. 2A is a cross sectional view, and FIG. 2B is a plan view.

FIG. 3 is a side view of the three-dimensional object manufactured by the manufacturing method of a three-dimensional object of the present disclosure illustrated in FIGS. 1A to 1C and FIGS. 2A and 2B.

FIGS. 4A to 4D are diagrams for explaining a manufacturing method of a three-dimensional object of the present disclosure having a different shape from the three-dimensional object illustrated in FIG. 3, where FIG. 4A is a diagram for explaining an uncured ink layer forming step, and FIGS. 4B, 4C, and 4D are diagrams for explaining a cured ink layer forming step.

FIG. 5 is a diagram for explaining the manufacturing method of a three-dimensional object having a different shape from the three-dimensional object illustrated in FIG. 3.

FIG. 6 is a side view of the three-dimensional object manufactured by the manufacturing method of a three-dimensional object illustrated in FIGS. 4A to 4D and FIG. 5.

### DETAILED DESCRIPTION OF EMBODIMENTS

Hereinbelow, embodiments according to the present disclosure will be described with reference to the drawings.

### Manufacturing Method of Three-Dimensional Object

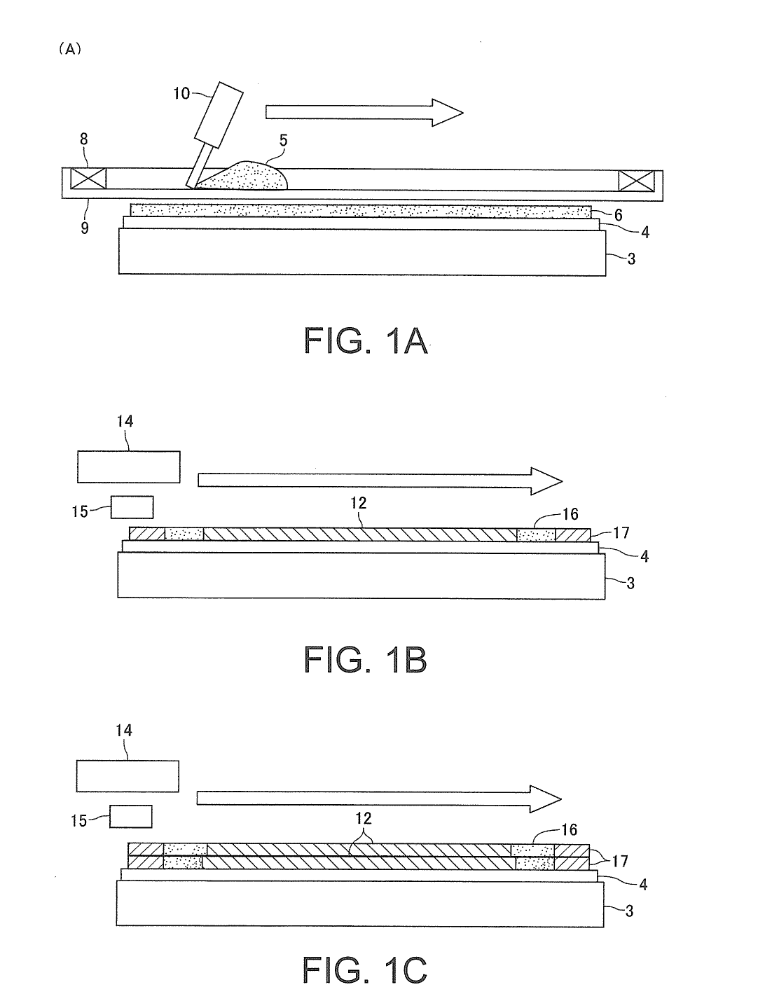

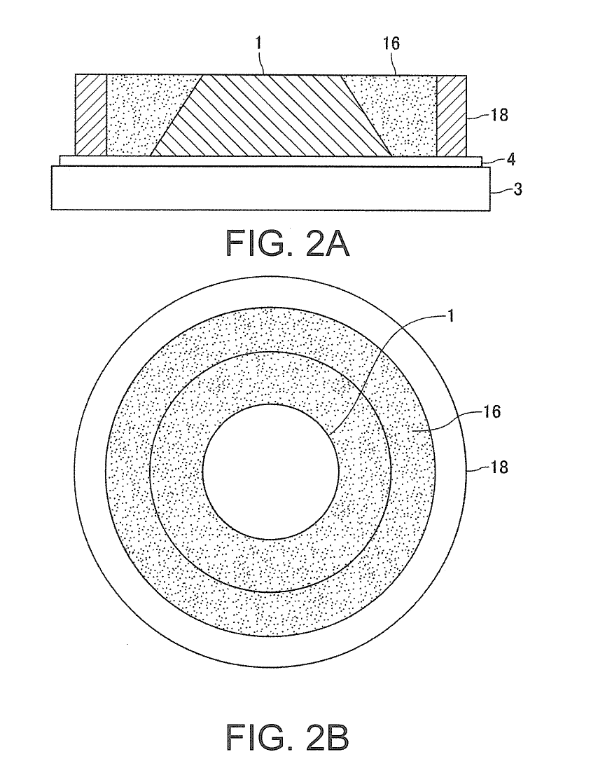

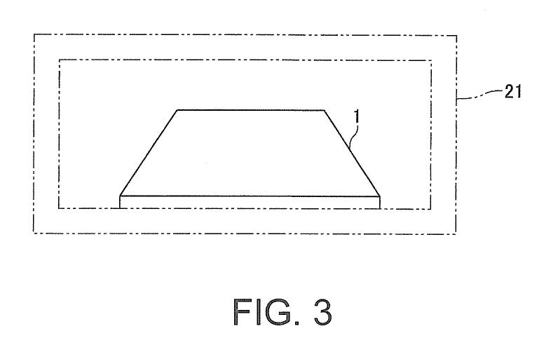

FIGS. 1A to 1C are diagrams for explaining a manufacturing method of a three-dimensional object according to an embodiment of the present disclosure, where FIG. 1A is a diagram for explaining an uncured ink layer forming step, and FIGS. 1B and 1C are diagrams for explaining a cured ink layer forming step. FIGS. 2A and 2B are diagrams illustrating a state after a 3D object forming step of the embodiment of the present disclosure, where FIG. 2A is a cross sectional view, and FIG. 2B is a plan view. FIG. 3 is a side view of the three-dimensional object manufactured by the manufacturing method of a three-dimensional object 1 illustrated in FIGS. 1A to 1C and FIGS. 2A and 2B.

The three-dimensional object 1 (see FIG. 3) manufactured by the manufacturing method of a three-dimensional object of the present embodiment is for example an object in a shape of a truncated cone. This three-dimensional object 1 is manufactured as follows. Firstly, as illustrated in FIG. 1A, photo-curing ink 5 is printed by screen printing, and an uncured ink layer 6 being a layer of uncured photo-curing ink 5 is formed on a releasing layer 4 formed on a stage 3 (uncured ink layer forming step). That is, the uncured ink layer 6 is formed on the releasing layer 4 by the screen printing using a screen 9 fixed to a frame 8 and a squeegee 10. In the present embodiment, in the uncured ink layer forming step, a disk-shaped uncured ink layer 6 is formed. Further, a thickness of the uncured ink layer 6 thus formed is for example 1 μm to 10 μm.

Here, the photo-curing ink 5 of the present embodiment is ultraviolet curing ink (UV ink) that is cured when ultraviolet ray is irradiated. More specifically, the photo-curing ink 5 is water-soluble UV ink. The releasing layer 4 is for example a coating configured of silicone resin or fluorescent resin. The screen 9 is formed in a meshed shape (webbed shape). The screen 9 is formed by braiding metal lines or resin lines, or by etching a metal film or a resin film. Further, the screen 9 has a print pattern formed by resist. A thickness of the screen 9 and coarseness of the mesh thereof are selected according to the thickness of the uncured ink layer 6. For example, the coarseness of the mesh in the screen 9 is set to a few meshes to several thousand meshes per inch.

Note that viscosity of the uncured photo-curing ink 5 is preferably equal to or greater than several thousand to several hundred thousand mPa·sec in order to maintain the shape of the uncured ink layer 6. Further, the photo-curing ink 5 may contain for example at least one of metal powder, ceramic powder, nonorganic fillers (specifically, nonorganic fillers such as rock, sand, or metal oxides), resin or rubber powder or solution, fibers (specifically, fibers such as carbon nanotubes, plant fibers, papyrus powder, cellulose, or wooden chip), colorant materials, and powder of thermos-curing resin or the like. In a case where the ceramic powder is included in the photo-curing ink 5, glazing powder may be included in the photo-curing ink 5. Further, in a case where the colorant materials are included in the photo-curing ink 5, a color of the colorant material to be included in the photo-curing ink 5 may be changed for each of the uncured ink layers 6 that are formed in plural layers as will be described later. Further, in a case where the stage 3 itself is formed of silicone resin or fluorescent resin, the releasing layer 4 may not be formed on the stage 3.

When the uncured ink layer 6 is formed on the releasing layer 4, then as illustrated in FIG. 1B, light is irradiated onto a predetermined portion of the uncured ink layer 6 to cure the predetermined portion of the uncured ink layer 6 to form a cured ink layer 12 (cured ink layer forming step). In the cured ink layer forming step, a UV-LED array 14 in which a plurality of light emitting diodes (UV-LEDs) that emit ultraviolet ray are arranged, and a lens array 15 are used to irradiate the ultraviolet ray emitted from the UV-LED array 14 to the predetermined portion of the uncured ink layer 6 through the lens array 15, and the predetermined portion of the uncured ink layer 6 is completely cured to form the cured ink layer 12.

In the UV-LED array 14, the UV-LEDs are arranged along a direction vertical to a sheet surface of FIGS. 1A to 1C. Further, a resolution of the UV-LED array 14 is for example 1200 dpi to 600 dpi. In the cured ink layer forming step, the UV-LED array 14 and the lens array 15 scan in a left and right direction of FIGS. 1A to 1C. Further, in the cured ink layer forming step, the UV-LEDs selected from among the plurality of UV-LEDs are lit while the UV-LED array 14 is scanning, so that the cured ink layer 12 can have a shape suitable for configuring a part of the three-dimensional object 1. In the present embodiment, in the cured ink layer forming step, the disk-shaped cured ink layer 12 is formed.

Further, in the cured ink layer forming step, an outer circumferential portion of the uncured ink layer 6 is cured by irradiating the light onto the outer circumferential portion of the uncured ink layer 6 surrounding a periphery (outer circumferential side) of the cured ink layer 12, and an outflow preventing section 17 that prevents an outflow of the uncured photo-curing ink 5 to the outer circumferential side of the uncured ink layer 6 is thereby formed. At this occasion, the outer circumferential portion of the uncured ink layer 6 is completely cured to form the outflow preventing section 17. In the present embodiment, in the cured ink layer forming step, an outer circumferential end portion of the uncured ink layer 6 is completely cured to form a ring-shaped outflow preventing section 17. Hereinbelow, the uncured photo-curing ink 5 that did not cure in the cured ink layer forming step will be termed “uncured ink 16”.

Thereafter, an uncured photo-curing ink 5 is printed by the screen printing on the first layer of cured ink layer 12, the uncured ink 16, and the outflow preventing section 17 to form a disk-shaped uncured ink layer 6 (uncured ink layer following step). Further, as illustrated in FIG. 1C, the light is irradiated onto a predetermined portion of the uncured ink layer 6 formed in this uncured ink layer forming step to completely cure the predetermined portion of the uncured ink layer 6 to form a cured ink layer 12 (cured ink layer forming step). In this cured ink layer forming step as well, an outflow preventing section 17 is formed. Thereafter, an uncured photo-curing ink 5 is printed by the screen printing on the second layer of cured ink layer 12, the uncured ink 16, and the outflow preventing section 17 to form a disk-shaped uncured ink layer 6 (uncured ink layer forming step), the light is irradiated onto a predetermined portion of the uncured ink layer 6 formed in this uncured ink layer forming step to completely cure the predetermined portion of the uncured ink layer 6 to form a cured ink layer 12 (cured ink layer forming step). In this cured ink layer forming step as well, an outflow preventing section 17 is formed.

Hereafter, in a similar way, the cured ink layers 12 are laminated by repeating the uncured ink layer forming steps and the cured ink layer forming steps to form the three-dimensional object 1 as illustrated in FIGS. 2A and 2B (3D object forming step). In this 3D object forming step, an outflow preventing dam 18 is formed by the laminated outflow preventing sections 17. Thereafter, the uncured ink 16 that did not cure in the cured ink layer forming steps is removed (uncured ink removing step). Further, the outflow preventing dam 18 is removed, and the three-dimensional object 1 is detached from the releasing layer 4. When the three-dimensional object 1 is detached from the releasing layer 4, the three-dimensional object 1 is completed. Note that, in FIG. 2B, depiction of the stage 3 and the releasing layer 4 is omitted.

### Primary Effects of the Present Embodiment

As described above, in the present embodiment, since the uncured ink layer 6 being the layer of the uncured photo-curing ink 5 is formed by the screen printing, the uncured ink layer 6 having a certain thickness can be formed according to a thickness of the screen 9 even if an area of the uncured ink layer 6 is enlarged. That is, in the present embodiment, even if the area of the uncured ink layer 6 is enlarged to manufacture a large three-dimensional object 1, the uncured ink layer 6 having a certain thickness can still be formed. Thus, in the present embodiment, even in the case of manufacturing a relatively large three-dimensional object 1, the cured ink layer 12 having a certain thickness can be formed by curing a predetermined portion of the uncured ink layer 6 having the certain thickness. As a result, in the present embodiment, even in the case of manufacturing a relatively large three-dimensional object 1, the three-dimensional object 1 can be manufactured accurately by the laminated cured ink layers 12.

In the present embodiment, in the uncured ink removing step, the uncured ink 16 that did not cure in the cured ink layer forming step is removed. Due to this, in the present embodiment, the uncured ink 16 removed in the uncured ink removing step can be reused in the screen printing of the uncured ink layer forming step. Accordingly, in the present embodiment, the amount of the photo-curing ink 5 used to manufacture one piece of three-dimensional object 1 can be reduced.

In the present embodiment, the photo-curing ink 5 is water-soluble UV ink. Due to this, in the present embodiment, for example, if the manufactured three-dimensional object 1 is defective, the cured photo-curing ink 5 (that is, the three-dimensional object 1) can be dissolved in water to return to its uncured state. Further, the photo-curing ink 5 that has been returned to the uncured state can be reused in the screen printing of the uncured ink layer forming step.

In the present embodiment, in the cured ink layer forming step, the outflow preventing section 17 for preventing the outflow of the uncured ink 16 to the outer circumferential side of the uncured ink layer 6 is formed. Due to this, in the present embodiment, the outflow of the uncured ink 16 can be prevented by the outflow preventing section 17 even if a frame member or the like for preventing the outflow of the uncured ink 16 to the outer circumferential side of the uncured ink layer 6 is not provided. Thus, in the present embodiment, a configuration of a manufacturing device of the three-dimensional object 1 can be simplified. Further, in the present embodiment, it becomes possible to retain the screen 9 by the outflow preventing section 17 so that the screen 9 becomes parallel to the cured ink layer 12.

### Variant of Manufacturing Method of Three-Dimensional Object

In the aforementioned embodiment, when the three-dimensional object 1 is detached from the releasing layer 4, the three-dimensional object 1 is completed. Other than this, if the photo-curing ink 5 contains metal powder, ceramic powder, or thermo-curing resin powder, a base model of the three-dimensional object 1 is formed by the 3D object forming step, and the three-dimensional object 1 may be manufactured by heating the base model of the three-dimensional object 1 in a heating furnace 21 (see FIG. 3) after the base model of the three-dimensional object 1 is detached from the releasing layer 4. That is, if the photo-curing ink 5 contains metal powder, ceramic powder, or thermo-curing resin powder, a heating step of heating the base model of the three-dimensional object 1 formed by the 3D object forming step to manufacture the three-dimensional object 1 may be provided after the uncured ink removing step.

For example, if the photo-curing ink 5 contains metal powder, the base model of the three-dimensional object 1 may be baked in the heating step and sintered metal thereof may be manufactured as the three-dimensional object 1. Further, if the photo-curing ink 5 contains ceramic powder, the base model of the three-dimensional object 1 may be baked in the heating step and ceramic may be manufactured as the three-dimensional object 1. In the case of baking the base model of the three-dimensional object 1 in the heating step to manufacture the sintered metal or ceramic thereof as the three-dimensional object 1, if the photo-curing ink 5 is water-soluble UV ink, it becomes relatively easy to remove the photo-curing ink 5 in the heating step; thus, the sintered metal or ceramic can be manufactured relatively easily.

### Variant of Shape of Three-Dimensional Object

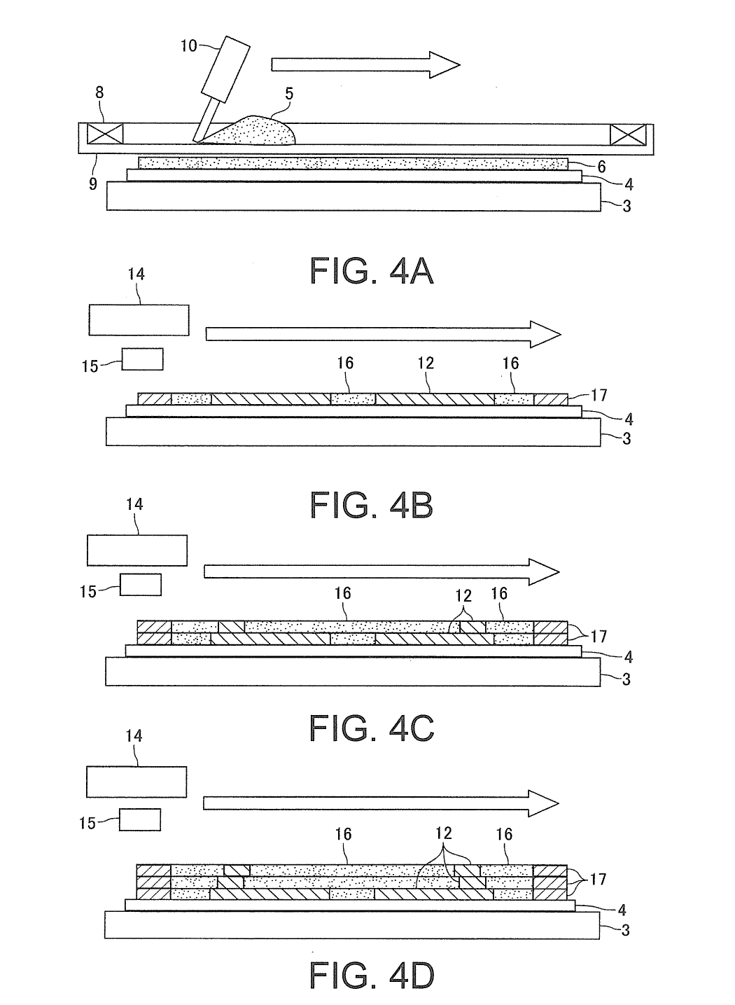

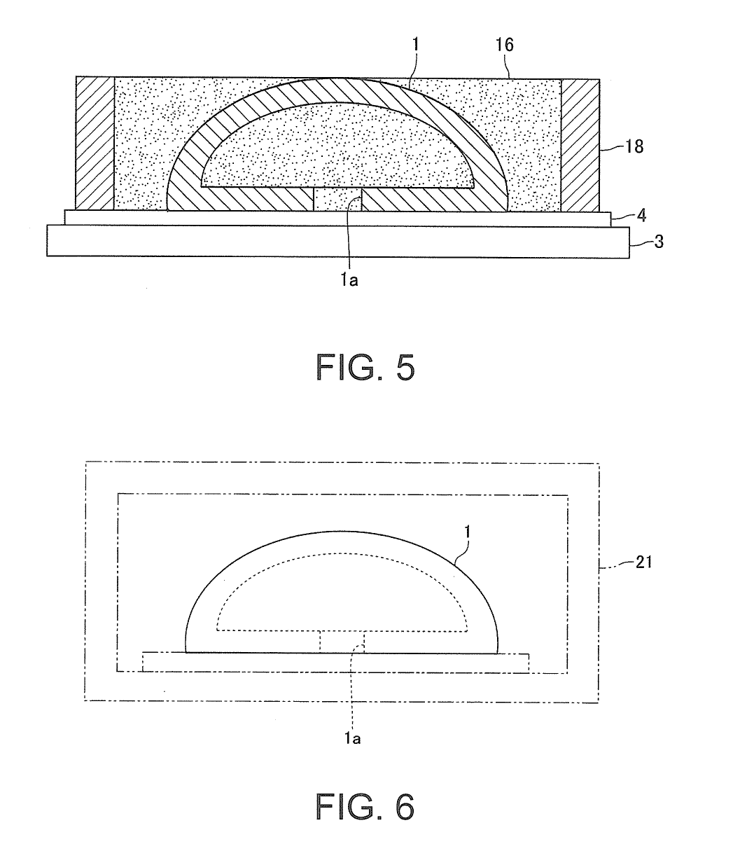

In the aforementioned embodiment, the shape of the three-dimensional object 1 is a truncated cone shape. However, the shape of the three-dimensional object 1 may be shapes other than the truncated cone shape. For example, the three-dimensional object 1 may be formed in a hollow semispherical shape as illustrated in FIGS. 5 and 6. Even in this case, upon manufacturing the three-dimensional object 1, firstly the uncured photo-curing ink 5 is printed by screen printing on the releasing layer 4 formed on the stage 3 as illustrated in FIG. 4A to form a disk-shaped uncured ink layer 6 (uncured ink layer forming step). Thereafter, as illustrated in FIG. 4B, the light is irradiated onto the predetermined portion of the uncured ink layer 6 to completely cure the predetermined portion of the uncured ink layer 6 to form the ring-shaped cured ink layer 12 (cured ink layer forming step). In this cured ink layer forming step, the ring-shaped outflow preventing section 17 is also formed.

Thereafter, an uncured photo-curing ink 5 is printed by the screen printing on the first layer of cured ink layer 12, the uncured ink 16, and the outflow preventing section 17 to form a disk-shaped uncured ink layer 6 (uncured ink layer forming step), then the light is irradiated as illustrated in FIG. 4C onto a predetermined portion of the uncured ink layer 6 formed in this uncured ink layer forming step to completely cure the predetermined portion of the uncured ink layer 6 to form a ring-shaped cured ink layer 12 (cured ink layer forming step). In this cured ink layer forming step as well, the ring-shaped outflow preventing section 17 is formed. Thereafter, an uncured photo-curing ink 5 is printed by the screen printing on the second layer of cured ink layer 12, the uncured ink 16, and the outflow preventing section 17 to form a disk-shaped uncured ink layer 6 (uncured ink layer forming step), then the light is irradiated as illustrated in FIG. 4D onto a predetermined portion of the uncured ink layer 6 formed in this uncured ink layer forming step to completely cure the predetermined portion of the uncured ink layer 6 to form a ring-shaped cured ink layer 12 (cured ink layer forming step). In this cured ink layer forming step as well, the ring-shaped outflow preventing section 17 is formed.

Hereafter, in a similar way, the cured ink layers 12 are laminated by repeating the uncured ink layer forming steps and the cured ink layer forming steps to form the three-dimensional object 1 as illustrated in FIG. 5 (3D object forming step). Thereafter, the uncured ink 16 that did not cure in the cured ink layer forming steps is removed (uncured ink removing step). Further, the outflow preventing dam 18 is removed, and the three-dimensional object 1 is detached from the releasing layer 4. When the three-dimensional object 1 is detached from the releasing layer 4, the three-dimensional object 1 is completed.

Note that a through hole 1a for removing the uncured ink 16 from the three-dimensional object 1 formed in the hollow shape is provided at a bottom surface portion of the three-dimensional object 1. Further, if the photo-curing ink 5 contains metal powder, ceramic powder, or thermo-curing resin powder, a base model of the three-dimensional object 1 is formed by the 3D object forming step, and the three-dimensional object 1 may be manufactured by heating the base model of the three-dimensional object 1 in the heating furnace 21 (see FIG. 6) after the base model of the three-dimensional object 1 is detached from the releasing layer 4. Further, this three-dimensional object 1 is formed in the hollow shape, and in the 3D object forming step, there is a case where the cured ink layer 12 of one of the layers is brought into an overhanging state with respect to the cured ink layer 12 arranged on the lower side thereof. The cured ink layer 12 in the overhanging state is retained by the uncured ink 16 on the lower side thereof so that it will not collapse.

### Other Embodiment

In the aforementioned embodiment, the photo-curing ink 5 is water-soluble UV ink. However, the photo-curing ink 5 may be UV ink that does not have water solubility. Further, the photo-curing ink 5 may be solvent UV ink in which UV curing resin is diluted by organic solvent. In this case, the UV curing resin included in the photo-curing ink 5 is for example one type of resin that cures by radical polymerization or cationic polymerization, or a mixture thereof. Further, the photo-curing ink 5 may be ink that cures when light other than the ultraviolet ray is irradiated. For example, the photo-curing ink 5 may be ink that is cured by being irradiated with visible light.

In the aforementioned embodiment, in the cured ink layer forming step, the high-resolution UV-LED array 14 is used as the light source for irradiating the ultraviolet ray to the predetermined portion of the uncured ink layer 6. Other than this, for example, a laser device such as a fiber laser, ultraviolet laser, semiconductor layer, or excimer laser may be used as the light source for irradiating the ultraviolet ray to the predetermined portion of the uncured ink layer 6. Further, in the case where the photo-curing ink 5 is the ink that cures when light other than the ultraviolet ray is irradiated, the light source corresponding to the type of the photo-curing ink 5 may be used in the cured ink layer forming step.

In the aforementioned embodiment, in the case where the viscosity of the photo-curing ink 5 printed by the uncured ink layer forming step is low, the ultraviolet ray with low intensity may be irradiated to the photo-curing ink 5 printed in the uncured ink layer forming step to increase the viscosity of the photo-curing ink 5. Further, in the aforementioned embodiment, the outflow preventing section 17 is formed in the cured ink layer forming step. However, if the viscosity of the photo-curing ink 5 is relatively high, the outflow preventing section 17 does not have to be formed in the cured ink layer forming step. Further, in the aforementioned embodiment, the releasing layer 4 is a coating such as silicone resin or fluorescent resin. However, the releasing layer 4 may be a resin coating that dissolves in water or specific solution, such as the water-soluble resin or ultraviolet curing resin. Further, in the aforementioned embodiment, if colorant materials are not included in the photo-curing ink 5, the three-dimensional object 1 may be colored afterwards by using a secondary decorating method.

What is claimed is:

1. A manufacturing method of a three-dimensional object, comprising:
a 3D object forming step of forming the three-dimensional object or a base model of the three-dimensional object by laminating cured ink layers, by repeating an uncured ink layer forming step of forming an uncured ink layer, which is an uncured photo-curing ink layer, by screen printing and a cured ink layer forming step of forming a cured ink layer by curing a predetermined portion of the uncured ink layer by irradiating light to the predetermined portion of the uncured ink layer; and
an uncured ink removing step of removing uncured photo-curing ink, which did not cure in the cured ink layer forming step, after the 3D object forming step.

2. The manufacturing method of a three-dimensional object according to claim 1, wherein
in the cured ink layer forming step, light is irradiated to surround the cured ink layer and onto an outer circumferential portion of the uncured ink layer to cure the outer circumferential portion of the uncured ink layer, so as to form an outflow preventing section for preventing an outflow of the uncured photo-curing ink to an outer circumferential side of the uncured ink layer.

3. The manufacturing method of a three-dimensional object according to claim 1, wherein
the uncured photo-curing ink is ultraviolet curing ink.

4. The manufacturing method of a three-dimensional object according to claim 2, wherein
the uncured photo-curing ink is ultraviolet curing ink.

5. The manufacturing method of a three-dimensional object according to claim 1, wherein
the uncured photo-curing ink is water-soluble ultraviolet curing ink.

6. The manufacturing method of a three-dimensional object according to claim 2, wherein
the uncured photo-curing ink is water-soluble ultraviolet curing ink.

7. The manufacturing method of a three-dimensional object according to claim 1, wherein
the uncured photo-curing ink contains metal powder, ceramic powder, or thermo-curing resin powder, and
the manufacturing method of the three-dimensional object further includes: a heating step of heating the base model of the three-dimensional object formed by the 3D object forming step to manufacture the three-dimensional object, and
the heating step taking place after the uncured ink removing step.

8. The manufacturing method of a three-dimensional object according to claim 2, wherein
the uncured photo-curing ink contains metal powder, ceramic powder, or thermo-curing resin powder, and
the manufacturing method of the three-dimensional object further includes: a heating step of heating the base model of the three-dimensional object formed by the 3D object forming step to manufacture the three-dimensional object, and
the heating step taking place after the uncured ink removing step.

9. The manufacturing method of a three-dimensional object according to claim 1, wherein
a light source that irradiates the light to predetermined portions of the uncured ink layer in the cured ink layer forming step is a UV-LED array in which a plurality of light emitting diodes that emit ultraviolet ray are arranged, or a laser device.

10. The manufacturing method of a three-dimensional object according to claim 2, wherein
a light source that irradiates the light to predetermined portions of the uncured ink layer in the cured ink layer forming step is a UV-LED array in which a plurality of light emitting diodes that emit ultraviolet ray are arranged, or a laser device.
